(19) United States
(12) Patent Application Publication
(10) Pub. No.: US 2025/0320413 A1
(43) Pub. Date: Oct. 16, 2025

(54) METHODS AND SYSTEMS FOR PROCESSING FLUIDS USING A CRACKING SYSTEM

(71) Applicant: Lummus Technology LLC, Houston, TX (US)

(72) Inventors: Kandasamy M. Sundaram, Houston, TX (US); Thomas W. Gronauer, Houston, TX (US); Baozhong Zhao, Houston, TX (US); Jose De Barros, Houston, TX (US)

(73) Assignee: Lummus Technology LLC, Houston, TX (US)

(21) Appl. No.: 19/173,703

(22) Filed: Apr. 8, 2025

Related U.S. Application Data
(60) Provisional application No. 63/634,272, filed on Apr. 15, 2024.

(51) Int. Cl. C10G 9/18; C10G 9/36

(52) U.S. Cl. CPC C10G 9/18; C10G 9/36

(57) ABSTRACT

A cracking system may include a fired heater having convection section and a radiant section having a combustion chamber. The cracking system may include at least one burner interfacing with the combustion chamber. The cracking system may include an air supply line fluidly connecting an air supply to the combustion chamber. The cracking system may include a turbomachine fluidly connected to the air supply line and the at least one burner. The cracking system may include a fuel supply line connecting a fuel supply to the at least one burner.

### BACKGROUND

A fired heater, also known as a process heater or industrial furnace, is a piece of equipment used for heating fluids or gases in various industrial processes that involve the combustion of a fuel to generate heat. Fired heaters may be used in industries such as oil and gas, petrochemicals, refining, and manufacturing, for processes requiring elevated temperatures.

Current fired heaters are predominantly fuel fired, generating carbon dioxide when firing hydrocarbon fuels, which is a source of greenhouse gases. Some electric heaters have been developed, but their designs have been limited, e.g., limited capacity or limits due to potential damage to electrical heating elements from combustion overheating or carburization.

Typical fired heaters include a combustion chamber, in which an air-fuel mixture may be combusted by the use of burners, and a heat exchanger, which transfers heat from the combustion process to the fluid or gas being heated by the fired heater. An air supply system may deliver air into the combustion chamber, and a fuel supply system may deliver fuel (e.g., natural gas, diesel, or other liquid or gaseous fuels) to the combustion chamber via pipes, valves, and control mechanisms in amounts according to a selected air-fuel ratio.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspects, the techniques described herein relate to a cracking system. The cracking system may include a fired heater, an air supply line, a turbomachine, and a fuel supply line. The fired heater may include a convection section and a radiant section having a combustion chamber, and at least one burner. The at least one burner interfaces with the combustion chamber. The air supply line may fluidly connect an air supply to the combustion chamber. The turbomachine may be fluidly connected to the air supply line and the at least one burner. The fuel supply line may connect a fuel supply to the at least one burner.

In some aspects, the techniques described herein relate to a method of processing fluids in a cracking system. The method may include directing an air supply through a turbomachine to preheat the air supply. The method may include directing the preheated air supply to a combustion chamber in a fired heater. The method may include combusting the preheated air supply in the combustion chamber. The method may include directing a hydrocarbon feed from a hydrocarbon feed line through one or more cracking tubes extending through the combustion chamber in the fired heater. The method may include using the combusting in the combustion chamber to heat the hydrocarbon feed in the one or more cracking tubes, cracking one or more hydrocarbons in the hydrocarbon feed, and generating a cracked hydrocarbon product.

Other aspects and advantages will be apparent from the following description and the appended claims.

### BRIEF DESCRIPTION OF DRAWINGS

FIG. 1 depicts a cracking system in accordance with one or more embodiments.

FIG. 2 depicts a cracking system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Although multiple dependent claims are not introduced, it would be apparent to one of ordinary skill that the subject matter of the dependent claims of one or more embodiments may be combined with other dependent claims.

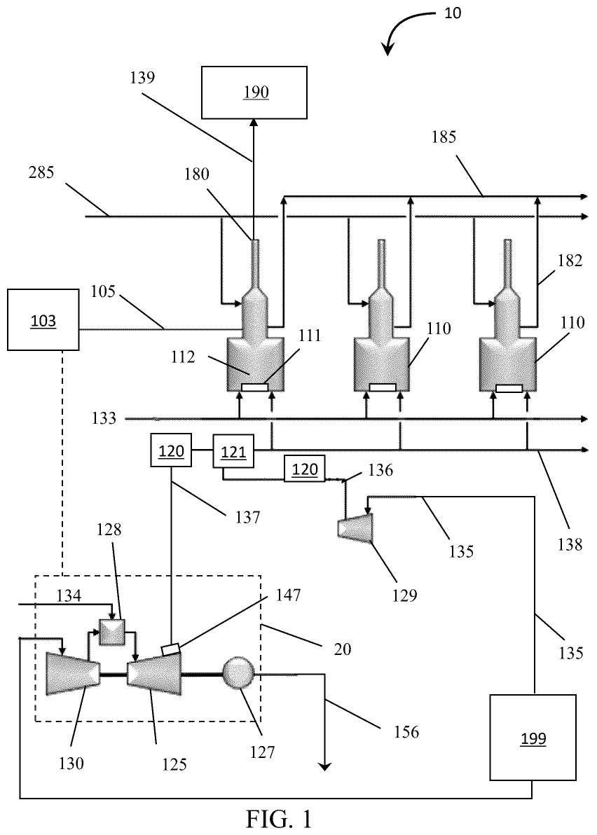

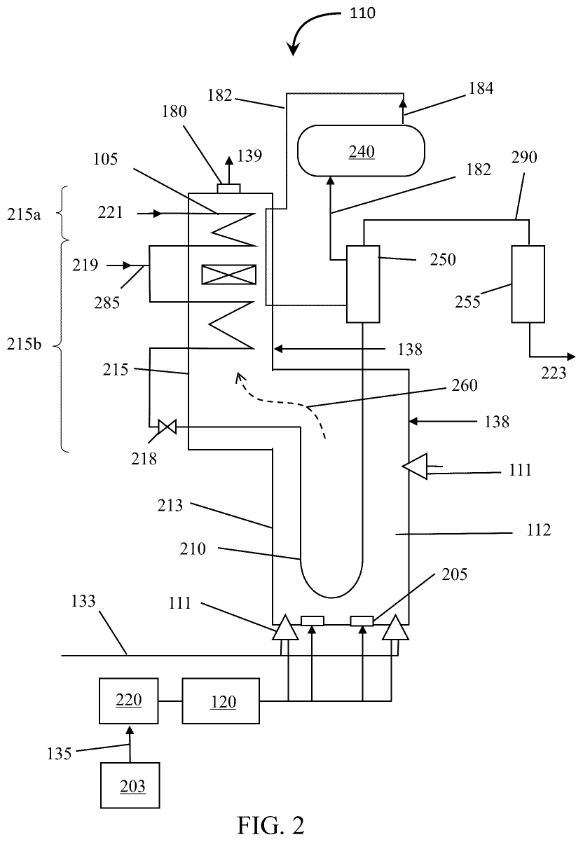

In the following description of FIGS. 1-2, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Heating fluids such as air requires thermal energy from a thermal source. Fired heaters are able to supply the thermal energy necessary to heat air to a suitable temperature for many applications such as cracking hydrocarbons. Fired heaters generally use fossil fuels. Combusting fossil fuels emits carbon dioxide (“CO₂”). The more air that needs to be heated above the temperature of input air to achieve the suitable temperature to crack hydrocarbons, the more fossil fuels are consumed in the combustion process and more carbon dioxide generated. Therefore, it is advantageous to preheat the air before the air is supplied to the fired heaters. If the air supply is preheated, such as by preheaters that utilize cleaner energy such as renewable energy, the volume of fossil fuel needed to heat the air may be reduced, thereby reducing CO₂ emissions.

FIG. 1 shows an example of a cracking system (10) according to embodiments of the present disclosure. The cracking system (10) may be operatively configured to receive a feed of one or more hydrocarbons to be cracked. The cracking system may include a control system (103). The control system (103) may be configured to control various operations of the cracking system (10), such as the operation of the combustion chamber. A method for processing fluids using a cracking system (hereafter “cracking method”) is disclosed herein. In some embodiments, the cracking method may use the cracking system (10) to produce process fluids (e.g., ethylene).

With respect to control systems, a control system (103) may include hardware and/or software that monitors and/or controls operations equipment (e.g., flow control valves, pumps, etc.) of one or more systems (e.g., heating systems, pump/compression systems, separation systems, flowline systems, and/or cracking systems) in accordance with one or more embodiments. The control system (103) may include computer systems with functionality to operate valves, warning alarms, fired heater operations, fluid levels, system pressures, and safety systems. The control system (103) may be operatively connected to hardware equipment of the one or more systems disclosed herein. The production system may also include other hardware equipment such as control and network elements for implementing the control system (103). Examples of control and network elements include, but not limited to, switches, routers, servers, terminal units, user equipment, and/or sensors.

With respect to cracking systems, the cracking system (10) may include one or more fired heaters (110), a power generation system (20), a fuel supply line (133), and an air supply line (135) (e.g., an air duct) in accordance with one or more embodiments. The air supply line (135) may include a fan line (136) having a fan (129), an exhaust gas line (137), and a preheated air line (138). The air supply line is configured to direct air from an air supply (e.g., a main air supply (199), an exhaust gas supply, an ambient air supply, a preheated air supply, or combination thereof). The cracking system (10) may include hardware components that support the operations of the cracking system (10) and that operatively connect the various components of the cracking system (10). Examples of hardware equipment may include fittings, valves, sensors, fluid lines, tubing, and/or electrical systems. The cracking system (10) may be operatively connected to the control system (103) to control cracking system operations. Even though FIG. 1 shows only one power generation system and fan, it will be apparent to one of ordinary skill in the art that a cracking system may include more than one power generation system and fan.

With respect to power generation systems, a power generation system (20) may include a compressor (130), a gas turbine (125) configured to rotate, a generator (127), and a fuel gas supply line (134) in accordance with one or more embodiments. The power generation system (20) is configured to generate electrical power and exhaust gases. The compressor (130) is operatively connected to the gas turbine (125). The gas turbine (125) is operatively connected to the generator (127). In some embodiments, the generator (127) is an electrical generator configured to generate electricity. The power generation system (20) may include hardware components to facilitate the generation of electrical power. Examples of hardware components may include, but are not limited to, tubing, pipes, cables, wiring, and fittings. The compressor (130) is configured to compress air from the air supply via the air supply line (135). In some embodiments, the cracking method may include compressing air in the compressor (130) to provide compressed air to the various systems such as the power generation system (20). The power generation system (20) may be operatively connected to the control system (103). The power generation system (20) may be configured to generate power and distribute the power to the hardware equipment of the cracking system (10) so that at least a portion of the generated electrical power is used to power the cracking system.

In accordance with one or more embodiments, the power generation system (20) may include an air-fuel mixture device (128). The air-fuel mixture device (128) receives fuel gas from the fuel gas supply line (134). The fuel gas supply line (134) is configured to transport fuel gas from a fuel supply. The fuel gas supply may include a fuel pump. The fuel pump pressurizes the fuel gas supply line (134) with the fuel gas to be supplied to the air-fuel mixture device (128). The air-fuel mixture device (128) also receives compressed air from the compressor (130). The air-fuel mixture device (128) is configured to mix the air and fuel to the appropriate ratio of the gas turbine (125). The compressor (130) is operatively connected to the gas turbine (125). The gas turbine (125) is configured to receive the air-fuel mixture from the air-fuel mixture device (128). In some embodiments, the cracking method may include directing the compressed air and fuel gas to the gas turbine (125).

The gas turbine (125) may operatively combust the fuel-air mixture, producing exhaust gases and generating power. In some embodiments, the cracking method may include the gas turbine (125) generating one or more exhaust gases from combusting the compressed air and fuel gas that may facilitate rotation of the gas turbine (125). The gas turbine (125) may include an exhaust gas outlet (147). The gas turbine (125) may expel exhaust gases from the exhaust gas outlet (147) to form the exhaust gas supply. The exhaust gases may be directed by the exhaust gas line (137). The exhaust gas line (137) is fluidly connected to the exhaust gas outlet (147) of the gas turbine (125). In some embodiments, the air supply line (135) fluidly connects the exhaust gas outlet (147) of the gas turbine (125) to the combustion chamber (112) in the fired heater (110). The cracking method may include using the exhaust gas in the air supply.

Continuing with power generation systems, the generator (127) is configured to produce electrical power from rotation of the turbine. The generator (127) may be electrically connected to a load via a power line (156). In some embodiments, the air-fuel mixture device (128) may include a bifurcated valve configured to combine multiple flows together. In some embodiments, the air-fuel mixture device (128) includes an air-fuel mixer. The air-fuel mixture device (128) may be connected to the control system (103). The cracking method may include using the gas turbine combusting to rotate the gas turbine. The control system (103) may be configured to adjust the air-fuel ratio appropriate for the power generation system (20). Even though FIG. 1 shows only one compressor, turbine, and generator (127), it will be apparent to one of ordinary skill in the art that the power generation system (20) may include more than one compressor, turbine, and generator (127).

Continuing with FIG. 1, the cracking system (10) may also include one or more turbomachines (120) in accordance with one or more embodiments. With respect to turbomachines, each turbomachine (120) may be a multistage axial compressor and/or a centrifugal compressor. The mechanical rotation of the turbomachine may be utilized to preheat the air supply. The cracking method may include directing the air supply through the one or more turbomachines (120) to preheat the air supply. The mechanical rotation of the turbomachine may introduce a shockwave that may convert rotational energy into heat. The heat converted from the rotational energy of the turbomachine may heat the air supply. The air supply line (135) (e.g., the fan line (136), and/or the exhaust gas line (137)) is configured to transport the air supply to one or more turbomachines (120). In some embodiments, each turbomachine (120) may be fluidly connected upstream from the one or more fired heaters (110) via the preheated air line (138). Even though there are several example arrangements of the turbomachines within the cracking system shown in FIG. 1, it will be apparent to one of ordinary skill in the art that the arrangement shown are not intended to be limiting and that many additional arrangements are possible.

In accordance with one or more embodiments, the fan line (136) may be operatively connected to the fan (129). In some embodiments, the fan (129) is configured to direct a flow of ambient air from the main air supply (199) to the one or more turbomachines (120). In some embodiments, the fan (129) may be configured to direct the flow of ambient air from the main air supply (199) to the one or more fired heaters (110). In some embodiments, the fan may direct a flow of ambient air to each fired heater (110) in place of directing air to each turbomachine if the exhaust gas is at a suitable temperature for the one or more fired heaters (110). The control system (103) may be configured to direct the flow of ambient air from the fan to the one or more fired heaters if the exhaust gas is at a suitable temperature for the fired heaters (110). The fan (129) may be fluidly connected downstream from the main air supply (199) via the air supply line (135).

In some embodiments, the main air supply (199) may include an air storage device and/or ambient air from surroundings of an ambient air collection device (e.g., the fan (129)). The ambient air supply from the fan (129) may be used to facilitate the combustion of the air-fuel mixture in each fired heater (110). The facilitation of the combustion may include supplying the air supply to avoid explosions in case a fired heater has unburnt fuel if the gas turbine trips (e.g., safety shutdown of the gas turbine (125)). In some embodiments, the fan line (136) may fluidly connect the fan (129) to each turbomachine (120). In some embodiments, the one or more turbomachines (120) may be fluidly connected downstream from a junction between the fan line (136) and the exhaust gas line (137). In some embodiments, the one or more turbomachines (120) are disposed in the exhaust gas line (137) between the exhaust gas outlet (147) and a junction between the fan line (136) and the exhaust gas line (137). In some embodiments, the one or more turbomachines (120) may be disposed in the fan line (136) between the fan (129) and a junction between the fan line (136) and the exhaust gas line (137). The cracking method may include directing the exhaust gas through the exhaust gas line to the junction. The cracking method may include directing ambient air through the fan line to the junction, where the ambient air mixes with the exhaust gas to form the air supply. In some embodiments, the fan line (136) may be fluidly connected directly to each fired heater (110).

Junctions may be where one or more fluid flows (e.g., main air supply (199), exhaust gases, preheated air, and/or ambient air) may mix to form the air supply. In some embodiments, a flow valve (121) may be disposed at one or more junctions to facilitate mixing of the two or more fluid flows (e.g., main air supply (199), exhaust gases, preheated air, and/or ambient air). In some embodiment, the one or more burners (111) (e.g., floor burners and/or wall burners) may receive the fuel supply and the preheated air. The fuel supply may mix, at least partially, with the preheated air. The air-fuel mixture may be ignited and combust, thereby generating heat.

Continuing with fired heaters, each fired heater (110) includes a convection section, a radiant section having a combustion chamber (112), and one or more burners (111) in accordance with one or more embodiments. The air supply (e.g., exhaust gases from the gas turbine (125), ambient air from the fan (129), air directly from the main air supply (199), or combinations thereof) is fluidly connected to the combustion chamber (112) via the air supply line (135) of each fired heater (110). In some embodiments, the air supply line (135) may be fluidly connected to the combustion chamber (112) via one or more air inlets (205) of the combustion chamber (112). In some embodiments, the one or more turbomachines (120) may be operatively disposed along the exhaust gas line (137) between the exhaust gas outlet (147) and a junction between the fan line (136) and the exhaust gas line (137). In some embodiments, the air supply line (135) is fluidly connected to the combustion chamber (112) via the one or more burners (111). The cracking method may include directing the preheated air supply to the combustion chamber (112) in the fired heater (110), in accordance with one or more embodiments.

In accordance with one or more embodiments, the fuel supply line (133) is fluidly connected to a fuel supply system. The fuel supply line (133) is configured to transport a flow of fuel from the fuel supply system to each fired heater (110). The fuel supply line (133) fluidly connects a fuel outlet of the fuel supply to each burner (111) via a fuel inlet. The fuel supply system may include a fuel pump and a fuel supply valve. The fuel pump is configured to pressurize the flow of fuel to provide the fuel flow. The fuel supply valve is configured to control the amount of fuel flow to the one or more burners (111). The fuel supply system may be operatively connected to the control system (103). The control system (103) may be configured to control the fuel flow to the cracking system (10).

In accordance with one or more embodiments, each fired heater (110) may include a flue gas outlet (180). The flue gas outlet (180) is configured to allow flue gas (260) from the combustion of fuel within the fired heater (110) to be released from the fired heater (110). The cracking system (10) may include a flue gas line (139) configured to transport the flue gas. The flue gas line (139) may be fluidly connected to the flue gas outlet (180). In some embodiments, the flue gas line (139) may be fluidly connected to a denox unit (190) downstream from the flue gas outlet (180) of the fired heater (110). The denox unit (190) is configured to remove nitrogen oxides (e.g., NOₓ such as nitrogen monoxide and nitrogen dioxide). The denox unit (190) may be configured to convert NOₓ to water and nitrogen gas (e.g., N₂). For example, the denox unit (190) may include a selective catalytic reduction (“SCR”) unit having a catalyst. The SCR unit may include a quantity of ammonia. The flue gas (260) may react with the catalyst and ammonia to produce the water and the nitrogen gas. SCR unit can be a compact unit used to reduce the excess NOₓ that is produced due to high temperature combustion air compared with ambient air. Therefore, instead of 85-95% NOₓ removal in typical SCR units 30-70% NOₓ removal can be used and this reduces the SCR catalyst volume and can be placed in existing heater structure. Though SCR unit is shown at the top of the convection for illustration, the SCR unit may be placed at any optimum location in the convection bank. Instead of one bed at one location, multiple locations can be considered.

Continuing with cracking systems, the cracking system (10) includes a hydrocarbon feed line (105) in accordance with one or more embodiments. The hydrocarbon feed line (105) is configured to transport a hydrocarbon feed (e.g., one or more hydrocarbons) to the one or more fired heaters (110). In some embodiments, the hydrocarbon feed (221) may include ethane, propane, butane, LPG, naphtha, gasoil, vacuum gasoil, hydrocracked AGO and VGO, crude oil, condensates, raffinates and recycle plastic pyoil, hydrogenated vegetable oils and other feeds that are used to produce ethylene in the industry.

The cracking system (10) may include a boiler feed line (182) and a steam header (185) in accordance with one or more embodiments. The boiler feed line (182) is fluidly connected to a steam supply system. In some embodiments, the steam supply system may be a transfer line exchanger as described in FIG. 2 and the accompanying description. The boiler feed line (182) is configured to transport a flow of steam from the steam supply system having a steam supply. The steam supply system is configured to supply a flow of steam. The boiler feed line (182) fluidly connects a boiler outlet of the steam supply to a steam inlet of each fired heater (110). In some embodiments, the boiler feed line (182) may be fluidly connected downstream to a convection section of each fired heater (110) as described in FIG. 2 and the accompanying description. The boiler feed line (182) may extend through the convection section (215) of each fired heater (110). The steam supply system may include a steam supply valve. The steam supply valve is configured to control the amount of steam flow to the one or more fired heaters (110). The steam supply system may be operatively connected to the control system (103). The control system (103) may be configured to control the steam flow to the cracking system (10). The steam header (185) may be fluidly connected to a steam outlet of each fired heater (110). The steam header (185) is configured to transport steam from the steam outlet. In some embodiments, the steam may be directed to the boiler feed line (182) to be reused by the one or more fired heaters (110).

In some embodiments, the exhaust gas and ambient air from the fan (129) may be mixed upstream from the turbomachine (120) before being directed through the turbomachine (120). The cracking method may include one or more turbomachines (120) where ambient air from the fan (129) may be directed through one turbomachine and the exhaust gas may be directed through another turbomachine. The preheated exhaust gas may be directed to the combustion chamber (112) via the air supply line (135) (e.g., the preheated air line (138)). The preheated ambient air may be directed to the combustion chamber (112) via the air supply line (135) (e.g., the preheated air line (138)). In some embodiments, the air supply may be directed through a preheater (220) and then directed through the one or more turbomachines (120).

In accordance with one or more embodiments, the cracking system (10) may include a dilution steam line (285) configured to direct a flow of dilution steam. The dilution steam line (285) may be fluidly connected to the steam supply system. The dilution steam line (285) may also be fluidly connected to the hydrocarbon feed line (105) between a first portion of a convection section and a second portion of the convection section of each fired heater (110) as described in FIG. 2 and the accompanying description.

FIG. 2 shows an example of the cracking system (10) and the one or more fired heaters (110) in accordance with one or more embodiments. Each fired heater (110) includes a radiant section (213) and a convection section (215), where each section includes coils of tubing (e.g., the hydrocarbon feed line (105)), and one or more cracking tubes (210)) configured for heat transfer between the hydrocarbon feed (221) (e.g., one or more hydrocarbons) circulated through the tubes and the flue gas (260) generated by combustion of an air-fuel mixture. The convection section (215) may include a first portion (215a) and a second portion (215b). The hydrocarbon feed line (105) may extend into the first portion (215a) of the convection section (215) (e.g., in a coiled arrangement). The radiant section (213) includes the combustion chamber (112), one or more burners (111) interfacing with the combustion chamber (112), and the cracking tube (210) extending through the combustion chamber (112) (e.g., in a coiled arrangement). The cracking tube (210) may be fluidly connected to the hydrocarbon feed line (105) and extends through the radiant section (213).

In accordance with one or more embodiments, the one or more burners (111) are used to ignite an air-fuel mixture within the combustion chamber (112), thereby generating the flue gas (260). The cracking method may include combusting the preheated air supply in the combustion chamber (112). The hydrocarbon feed (221) may be circulated through the tubing of each section, where heat may be transferred to the hydrocarbon feed (221) mainly by heat radiation from the one or more burners in the combustion chamber (112). The cracking method may include directing the hydrocarbon feed (221) from the hydrocarbon feed line (105) through the cracking tube (210) extending through the combustion chamber (112) in each fired heater (110). A cracked hydrocarbon product (223) may be generated from the hydrocarbon feed (221) due to the heat from the combusting in the combustion chamber (112). Flue gas (260) may exit the radiant section (213) and enter the second portion (215b) of the convection section (215). The cracking method may include using the combusting in the combustion chamber to heat the hydrocarbon feed in the one or more cracking tubes, cracking one or more hydrocarbons in the hydrocarbon feed, and generating the cracked hydrocarbon product.

In accordance with one or more embodiments, the hydrocarbon feed (221) flowing through convection tubing within the convection section (215), may be indirectly heated by convection from the flue gas (260). The hydrocarbon feed line (105) may first enter the convection tubing disposed in the first portion (215a) of the convection section (215), where the hydrocarbon feed (221) may be preheated by the flue gas (260) entering the convection section (215) from the radiant section (213). Heat transfer from the flue gas (260) to the hydrocarbon feed (221) may reduce the temperature of the flue gas (260) prior to exiting the fired heater (110) through the flue gas outlet (180). The dilution steam line (285) may then direct a flow of dilution steam (219) into the hydrocarbon feed line (105). The hydrocarbon feed (221) and dilution steam (219) may mix, at least partially, thereby diluting the hydrocarbon feed (221) with the dilution steam (219). In some embodiments, the dilution steam line (285) may be fluidly connected to the hydrocarbon feed line (105) between the first portion (215a) and the second portion (215b) of the convection section. The preheated hydrocarbon feed (221) and the dilution steam (219) may then flow through the second portion (215b) of the convection section (215) within the hydrocarbon feed line (105).

In accordance with one or more embodiments, the hydrocarbon feed (221) may then be directed through a control valve (218) to the radiant tubes in the radiant section (213), where the preheated hydrocarbon feed (221) is heated by radiation from combustion in the combustion section. The control valve (218) is configured to control the flow of preheated hydrocarbon feed (221) from the hydrocarbon feed line (105) to the cracking tube (210). The cracked hydrocarbon product (223) (e.g., the heated hydrocarbon feed) may then be directed to a transfer line (290). The transfer line (290) is fluidly connected to an outlet of the cracking tube (210). Instead of placing the control valves in the hydrocarbon and dilution steam mixed line, control valves can be used in controlling individual hydrocarbon and dilution steam flow rates to each of the individual heater.

In accordance with one or more embodiments, the cracking system (10) may include one or more transfer line heat exchangers (e.g., a primary transfer line exchanger (250) and a secondary transfer line exchanger (255)). The transfer line (290) may extend from the fired heater (110) to the one or more transfer line heat exchangers. The transfer line exchanger is fluidly connected to the outlet of the cracking tube (210) via the transfer line (290) extending from the fired heater (110) to the transfer line exchanger. In some embodiments, the transfer line (290) extends through the one or more heat exchangers. The one or more transfer line heat exchangers may include an outer shell. The outer shell may be configured to allow a flow of water (e.g., boiler feed water (184)) therethrough. The transfer line may be disposed, at least partially, within the outer shell. The flow of water through the outer shell cools the cracked hydrocarbon product (223) within the transfer line. The cooled cracked hydrocarbon product (223) may be directed to a storage facility, production systems for further processing, or transportation systems for transport. In some embodiments, the cracked hydrocarbon product (223) may transfer heat to the water in the outer shell converting the water to steam. The steam supply system may include a steam drum (240). The steam may be directed to the steam drum (240) via the boiler feed line (182). The steam drum (240) may be fluidly connected downstream from the primary transfer line exchanger (250) via the boiler feed line (182).

A portion of the steam may be directed to the steam header in accordance with one or more embodiments. The steam header (185) may be fluidly connected to the steam drum (240). The steam header may be configured to gather the portion of steam from each transfer line exchanger and direct the portion of steam to the steam drum (240).

In some embodiments, the cracking system (10) may include a preheater (220) disposed in the air supply line (135) (e.g., the fan line (136), and/or the exhaust gas line (137)) and configured to receive an air supply (203) (e.g., a main air supply (199), an exhaust gas supply, an ambient air supply, a preheated air supply, or combination thereof). The preheater (220) may be any device suitable for heating air. The preheater (220) may be operatively connected to the control system (103). The control system (103) may be configured to control the heating operations of the preheater (220). The electrical systems are configured to supply electrical power to the preheater (220). The preheater (220) is fluidly connected upstream of the one or more turbomachines (120). The preheater (220) may be configured to heat the air further before flowing to the turbomachine. The preheated air may be heated from the one or more turbomachines (120), or the preheater (220), or combination thereof. The preheated air may be directed to the combustion chamber (112) through one or more air inlets (205) disposed in multiple locations around the combustion chamber (112). The one or more air inlets (205) locations may be optimized to provide sufficient air during the heating of the hydrocarbon feed (221) (e.g., process fluids).

### Comparison Example:

In a first example, an ethylene production process uses fired heaters running on fossil fuels to supply the endothermic energy required for the pyrolysis process of producing ethylene from hydrocarbons, and thus emits CO₂. If the gas turbines used in the power generation process fail to supply exhaust gases (e.g., a gas turbine trips resulting in the gas turbine shutting down), the fired heaters are capable of operating using 100% ambient air to meet ethylene production. Using 100% ambient air as an air supply for input into the fired heaters requires heating the ambient air to a sufficient temperature in order to achieve hydrocarbon cracking. The oxygen content in ambient air is typically 21% of total air volume. The ambient air is typically at a temperature of about 80 degrees Fahrenheit (° F.) for input into the fired heaters. The fuel gas used for this example is methane off gas containing 15.93 mole percent (mol %) of H₂. The fuel gas at a flowrate of 26,709 pounds per hour (lb/hr) is directed to the fired heaters at a hydrocarbon feed flowrate of 163,266 (lb/hr). CO₂ produced from the fired heaters is approximately 64,385 lb/hr. Further details are available in Table 1.

In a second example, if the gas turbines are operating normally, the gas turbines are operated at very high excess air, and after extracting the power, the gas turbine exhaust is hot (e.g., 300-500° C.) and contains more than 12% oxygen, some CO2 and H2O (combustion products), and inert N2. While the oxygen content in the gas turbine exhaust (“GTE”) is less than the oxygen content in ambient air (21%), GTE has a higher temperature than ambient air. Hot GTE is supplied in air ducts to burners in the fired heaters and ambient air is mixed at a suitable location before it reaches the burners. The GTE air mixed with ambient air has a temperature of approximately 775 degrees Fahrenheit (° F.) for input into the fired heaters. The fuel gas used for this example is methane off gas containing 15.93 mol % of H₂. The fuel gas at a flowrate of 23,115 lb/hr is directed to the fired heaters at a hydrocarbon feed flowrate of 163,266 lb/hr. The amount of CO₂ produced from the fired heater is approximately 55,663 lb/hr. This example results in a 13.5% reduction in the CO₂ produced compared to the first example. Further details are available in Table 1.

In a third example, the GTE is heated using one or more turbomachines before being directed to the fired heater. The GTE is heated to 1832° F. with the turbomachine and then mixed with ambient air so the volume of GTE is ratio 68.4% of total volume. The fuel gas used for this example is methane off gas containing 15.93 mol % of H₂. The fuel gas at a flowrate of 19,046 lb/hr is directed to the fired heaters at a hydrocarbon feed flowrate of 163,266 lb/hr. The amount of CO₂ produced from the fired heater is 45,906 lb/hr. This example results in a CO₂ reduction of 28.7% compared to the first example. Further details are available in Table 1.

In a fourth example, the GTE is heated using one or more turbomachines before being directed to the fired heater. The GTE is heated to 1832° F. with the turbomachine and then mixed with ambient air so the volume of GTE is ratio 81% of total volume. The fuel gas used for this example is methane off gas containing 15.93 mol % of H₂. The fuel gas at a flowrate of 16,783 lb/hr is directed to the fired heaters at a flowrate of 163,266 lb/hr. The amount of CO₂ produced from the fired heater is 45,906 lb/hr. This example results in a CO₂ reduction of 28.7% compared to the first example. Further details are available in Table 1.

In a fifth example, if the GTE supply fails (e.g., a gas turbine trips resulting in the gas turbine shutting down), the fired heaters are capable of operating using 100% ambient air to meet ethylene production. Flue gas produced in the fired heater is used to preheat the ambient air before it is routed to burners. However, flue gas supply for preheating the ambient air is limited, as the flue gas is also used to heat super high-pressure steam generated in the fired heaters. Super high-pressure steam is used to drive compressors in the recovery section of the fired heater. When flue gas as a heat source is diverted from the steam needed to drive the compressors, other heat sources or imported super high-pressure steam is needed, which counteracts any CO₂ emission reduction from preheating the ambient air with flue gas. Thus, using flue gas from a fired heater as a heating source may not significantly reduce emissions.

An additional source of heat is needed to be able to reduce CO₂ emissions. The present disclosure uses preheaters and turbomachines to generate the heat. If the preheaters and turbomachines are powered by electricity generated by renewables, the additional heat may reduce CO₂ emissions by reducing the fuel and combustion needed to heat the air supply within the combustion chambers of the fired heaters. Turbomachines may be able to heat the air supply up to 1500° C.

TABLE 1
Hot Air Combined with GTE Operation

| Example | 1 | 2 | 3 | 4 |
|---|---|---|---|---|
| Feed | Naphtha | Naphtha | Naphtha | Naphtha |
| Flowrate, lb/hr | 163266 | 163266 | 163266 | 163266 |
| S/O, w/w | 0.5 | 0.5 | 0.5 | 0.5 |
| COP, psia | 25 | 25 | 25 | 25 |
| Conv.(%)/Severity (p/E, wt/wt) | 0.49 | 0.49 | 0.49 | 0.49 |
| Cross over Temp., F. | 1127 | 1170 | 1165 | 1163 |
| Coil outlet Temp., F. | 1552 | 1550 | 1550 | 1550 |
| Primary TLE outlet Temp., F. | 670 | 670 | 670 | 670 |
| C2H4 Production.kTA | 194 | 194 | 194 | 194 |
| Radiant duty, MMBTU/h | 218 | 209 | 210 | 210 |
| Fired Duty, MMBTU/h | 529 | 458 | 377 | 333 |
| SHP Steam, t/h | 103 | 112 | 111 | 111 |
| Overall efficiency,% | 94.6 | 94.3 | 94.6 | 94.7 |
| Stack Temp., F. | 214 | 224 | 223 | 223 |
| Excess air, % | 10 | 10 | 35 | 41 |
| Preheated GTE/Air temp., F. | 80.6 | 1111 | 1832 | 1832 |
| Combined Temp at H. Burner, F. | 80.6 | 775 | 1282 | 1543 |
| Mol % H2 in Fuel | 15.93 | 15.93 | 15.93 | 15.93 |
| Fuel, lb/h | 26709 | 23115 | 19046 | 16783 |
| Flue gas, lb/h | 497180 | 560113 | 561922 | 563047 |
| % CO2 in flue gas at stack | 12.95 | 13.61 | 11.87 | 11.83 |
| CO2 emission, lb/h | 64385 | 76231 | 66700 | 66608 |
| GTE used per heater | 0 | 347975 | 351784 | 442474 |
| Amb.air used, lb/h | 470471 | 189024 | 191092 | 103790 |
| CO2 in GTE, lb/h | 0 | 20569 | 20794 | 26150 |
| CO2 produced in htr only, lb/h | 64385 | 55663 | 45906 | 40458 |
| Air preheat duty, MW | 0.0 | 0.0 | 22.3 | 27.8 |
| Amount of H2 in fuel, lb/h | 589.7 | 510.4 | 420.5 | 370.6 |
| % CO2 reduction excl GTE | | 0.0 | 17.5 | 27.3 |
| % CO2 reduction in heater wrt amb.air | 0.0 | 13.5 | 28.7 | 37.2 |

Embodiments of the present disclosure may provide at least one of the following advantages. The present invention may be utilized in reducing carbon dioxide (CO₂) emissions by reducing the amount of combusting within the one or more fired heaters (110) to heat the process fluids. The present invention heats the air supply before being directed into the combustion chamber (112) to reduce the amount fuel needed to heat the air supply to heat the process fluids.

In these examples, using hot preheated air reduces the fuel consumption and thereby reduces CO₂ emission. Hydrogen is produced as a by-product when cracking all hydrocarbon feeds. Therefore, with reduced fuel consumption, hydrogen content of methane off gas will be richer in hydrogen, and hence it will reduce the CO₂ emission further. For certain feeds like ethane cracking methane off gas contains 60-80 mol % H₂ in the fuel. For such feeds, using very high temperature air results in almost 100% H₂ in the methane off gas. That is, hydrogen produced in the plant is sufficient to meet the fired duty. In those cases the fuel is nearly 100% H₂ leading to zero CO₂ emission. There is no import of H₂ required to attain net zero concept. At low preheated air, hydrogen produced as a byproduct is not sufficient for any hydrocarbon feed cracking. Using turbomachines permits to attain such high temperatures.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A cracking system, comprising:
a fired heater, comprising:
a convection section,
a radiant section having a combustion chamber, and
at least one burner interfacing with the combustion chamber;
an air supply line fluidly connecting an air supply to the combustion chamber;
a turbomachine fluidly connected to the air supply line and the at least one burner; and
a fuel supply line connecting a fuel supply to the at least one burner.

2. The cracking system of claim 1, further comprising an electric preheater disposed in the air supply line upstream from the turbomachine.

3. The cracking system of claim 1, further comprising:
a hydrocarbon feed line extending into a first portion of the convection section;
a dilution steam line fluidly connected to the hydrocarbon feed line between the first portion of the convection section and a second portion of the convection section; and
a cracking tube fluidly connected to the feed line and extending through the radiant section.

4. The cracking system of claim 3, further comprising:
a primary transfer line exchanger fluidly connected to an outlet of the cracking tube via a transfer line extending from the fired heater to the primary transfer line exchanger; and
a steam drum fluidly connected to the primary transfer line exchanger via a boiler feed line.

5. The cracking system of claim 1, wherein the air supply line is connected to the combustion chamber via at least one air inlet.

6. The cracking system of claim 1, wherein the air supply line is connected to the combustion chamber via the at least one burner.

7. The cracking system of claim 1, wherein the air supply comprises:
an ambient air supply; and
an exhaust gas supply,
wherein the exhaust gas supply is generated from a gas turbine, and
wherein the air supply line comprises an exhaust gas line fluidly connected to an exhaust gas outlet of the gas turbine.

8. A cracking system, comprising:
a fired heater,
a gas turbine;
an air supply line fluidly connecting an exhaust gas outlet of the gas turbine to a combustion chamber in the fired heater;
a turbomachine fluidly connected to the air supply line; and
a fuel supply line fluidly connecting a fuel supply to at least one burner in the fired heater.

9. The cracking system of claim 8, further comprising:
at least one additional fired heater,
wherein the fuel supply line is further connected to each of the at least one additional fired heater,
wherein the air supply line is further connected to each of the at least one additional fired heater, and
wherein the turbomachine is connected upstream from each of the fired heater and the at least one additional fired heater.

10. The cracking system of claim 8, wherein the air supply line comprises:
a fan line having a fan,
wherein the fan line fluidly connects the fan to the combustion chamber of the fired heater; and
an exhaust gas line fluidly connected to the exhaust gas outlet.

11. The cracking system of claim 10, wherein the turbomachine is downstream from a junction between the fan line and the exhaust gas line.

12. The cracking system of claim 10, wherein the turbomachine is disposed in the fan line between the fan and a junction between the fan line and the exhaust gas line.

13. The cracking system of claim 10, wherein the turbomachine is disposed in the exhaust gas line between the exhaust gas outlet and a junction between the fan line and the exhaust gas line.

14. The cracking system of claim 8, wherein the turbomachine is a multistage axial compressor.

15. The cracking system of claim 8, wherein the turbomachine is a centrifugal compressor.

16. The cracking system of claim 8, further comprising a denox unit connected downstream from a flue gas outlet of the fired heater.

17. A method of processing fluids in a cracking system, comprising:
directing an air supply through a turbomachine to preheat the air supply;
directing the preheated air supply to a combustion chamber in a fired heater;
combusting a fuel with the preheated air supply in the combustion chamber;
directing a hydrocarbon feed from a hydrocarbon feed line through one or more cracking tubes extending through the combustion chamber in the fired heater; and
using the combusting in the combustion chamber to heat the hydrocarbon feed in the one or more cracking tubes, cracking one or more hydrocarbons in the hydrocarbon feed, and generating a cracked hydrocarbon product.

18. The method of claim 17, further comprising:
compressing air in a compressor to provide compressed air;
directing the compressed air and fuel gas to a gas turbine; and
in the gas turbine, combusting the compressed air and the fuel gas to generate exhaust gas; and
using the exhaust gas in the air supply.

19. The method of claim 18, further comprising:
using the exhaust gas to rotate the gas turbine, wherein the gas turbine is connected to an electrical generator; and
using the rotation of the gas turbine to generate electrical power,
wherein at least a portion of the generated electrical power is used to power the cracking system.

20. The method of claim 18, wherein the cracking system comprises:
an air supply line, comprising:
a fan line having a fan; and
an exhaust gas line connected between an exhaust gas outlet and a junction with the fan line,
wherein the method further comprises:
directing the exhaust gas through the exhaust gas line to the junction; and
directing ambient air through the fan line to the junction, where the ambient air mixes with the exhaust gas to form the air supply.
